(19) United States
(12) Patent Application Publication
(10) Pub. No.: US 2020/0336854 A1
(43) Pub. Date: Oct. 22, 2020

(54) BILATERAL WIRELESS EARPHONE SYSTEM OF VR DEVICE AND BILATERAL WIRELESS EARPHONE OF VR DEVICE

(71) Applicant: GoerTek Technology Co., Ltd., Qingdao City (CN)

(72) Inventor: Weidong Wang, Qingdao City (CN)

(73) Assignee: GoerTek Technology Co., Ltd., Qingdao City (CN)

(21) Appl. No.: 16/098,450

(22) PCT Filed: Dec. 29, 2016
(86) PCT No.: PCT/CN2016/113242

§ 371 Date: Nov. 2, 2018

(30) Foreign Application Priority Data
Jul. 1, 2016 (CN) 201610506444.1

(51) Int. Cl. H04S 7/00; H04R 1/10

(52) U.S. Cl. CPC H04S 7/30; H04R 2420/07; H04R 1/1091

(57) ABSTRACT

A bilateral wireless earphone system of a VR device and a bilateral wireless earphone of a VR device are disclosed to solve the technical problem of the prior art that the head bearing weight is large in virtual reality experience. The bilateral wireless earphone system of a VR device comprises a VR device body, a first earphone of in-ear earbud type and a second earphone of in-ear earbud type. The VR device body comprises a wireless audio transmitting module. The first earphone comprises a first wireless audio receiving module. The second earphone comprises a second wireless audio receiving module. The wireless audio transmitting module is configured to broadcast audio data; the first wireless audio receiving module and the second wireless audio receiving module are both configured to receive the audio data that are broadcast by the wireless audio transmitting module.

### CROSS REFERENCE TO RELATED APPLICATIONS

This application is a U.S. National Stage entry under 35 U.S.C. § 371 based on International Application No. PCT/CN2016/113242, filed on Dec. 29, 2016, which was published under PCT Article 21(2) and which claims priority to Chinese Patent Application No. 201610506444.1, filed on Jul. 1, 2016. These priority applications are hereby incorporated herein in their entirety by reference.

### TECHNICAL FIELD

The present disclosure belongs to the technical field of virtual reality, and more particularly, relates to a bilateral wireless earphone system of a VR device and a bilateral wireless earphone of a VR device.

### BACKGROUND

VR (Virtual Reality) technology is a computer simulation system that can create and experience a virtual world. It uses a computer to generate a simulation environment in which users can be immersed, and is an interactive system simulation of 3D dynamic real-life scene and physical behavior by multi-source information fusion.

VR technology can be applied in many fields including medical, engineering, military, aviation, and navigation services. For example, in the aviation field, when an aerospace pilot performs various driving operations on the screen in a training cabin, the screen images simulating scenes outside the cabin change accordingly, and the pilot can feel the training effect of the virtual reality. This kind of virtual reality that places people into the image environment has also been widely used in entertainment, games, education and other fields.

In addition, other objects, desirable features and characteristics will become apparent from the subsequent summary and detailed description, and the appended claims, taken in conjunction with the accompanying drawings and this background.

### SUMMARY

The present disclosure provides a wireless bilateral earphone system of a VR device and a wireless bilateral earphone of a VR device.

The present disclosure adopts the following technical solutions:

In one aspect, the present disclosure provides a bilateral wireless earphone system of a VR device, comprising a VR device body, wherein the bilateral wireless earphone system of a VR device further comprises a first earphone of in-ear earbud type and a second earphone of in-ear earbud type;

the VR device body comprises a wireless audio transmitting module;

the first earphone comprises a first wireless audio receiving module, and the second earphone comprises a second wireless audio receiving module; and

the wireless audio transmitting module is configured to broadcast audio data, and the first wireless audio receiving module and the second wireless audio receiving module are both configured to receive the audio data that are broadcast by the wireless audio transmitting module.

In another aspect, the present disclosure provides a bilateral wireless earphone of a VR device, comprising: a first earphone of in-ear earbud type and a second earphone of in-ear earbud type; wherein

the first earphone comprises a first wireless audio receiving module, and the second earphone comprises a second wireless audio receiving module; and

the first wireless audio receiving module and the second wireless audio receiving module are both configured to receive the audio data that are broadcast by a wireless audio transmitting module of the VR device.

In the wireless bilateral earphone system of a VR device and the wireless bilateral earphone of a VR device, the first earphone further comprises a first audio processing module and a first speaker, and the second earphone further comprises a second audio processing module and a second speaker;

the first audio processing module is configured to convert the audio data received by the first wireless audio receiving module into a first analog audio signal, and the first speaker is configured to play the first analog audio signal; and

the second audio processing module is configured to convert the audio data received by the second wireless audio receiving module into a second analog audio signal, and the second speaker is configured to play the second analog audio signal.

### BRIEF DESCRIPTION OF DRAWINGS

The present invention will hereinafter be described in conjunction with the following drawing figures, wherein like numerals denote like elements, and:

FIG. 1 is a block diagram of a bilateral wireless earphone system of a VR device according to the present disclosure.

### DETAILED DESCRIPTION

The following detailed description is merely exemplary in nature and is not intended to limit the invention or the Application and uses of the invention. Furthermore, there is no intention to be bound by any theory presented in the preceding background of the invention or the following detailed description.

The specific embodiments of the present disclosure are described in further detail below with reference to the accompanying drawings.

At present, the most typical design of VR devices is the head-mounted helmet in which the user's eyes are in the virtual display space, and head-mounted earphones are equipped to experience the sound of the virtual environment. However, the head-mounted earphones are bulky and heavy. Thus, when experiencing the virtual reality technology, the user's head must bear a large weight including not only the weight of the VR device but also that of the head-mounted earphones, which will easily cause head fatigue and reduce the experience effect.

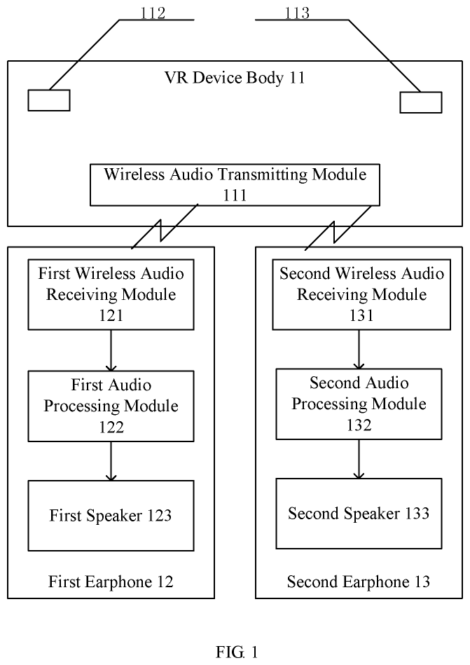

To solve the technical problem of the prior art that the head bearing weight is large in virtual reality experience, the present disclosure provides a bilateral wireless earphone system of a VR device. As shown in FIG. 1, the system comprises a VR device body 11, a first earphone 12 of in-ear earbud type and a second earphone 13 of in-ear earbud type. The VR device body 11 comprises a wireless audio transmitting module 111. The first earphone 12 comprises a first wireless audio receiving module 121. The second earphone 13 comprises a second wireless audio receiving module 131.

The wireless audio transmitting module 111 is configured to broadcast audio data. The first wireless audio receiving module 121 and the second wireless audio receiving module 131 are both configured to receive the audio data that are broadcast by the wireless audio transmitting module 111.

For example, if the first earphone 12 is the left sound channel earphone and the second earphone 13 is the right sound channel earphone, when the user is experiencing the virtual reality, the first earphone 12 is inserted into the left ear, and the second earphone 13 is inserted into the right ear. When the VR device body 11 broadcasts the audio data, the first earphone 12 and the second earphone 13 receive the broadcasted audio data based on the first wireless audio receiving module 121 and the second wireless audio receiving module 131 respectively, so that the left and right ears of the user hear the audio.

Compared with the prior art, the advantages and positive effects of the present disclosure are as follows. In the bilateral wireless earphone system of a VR device and the bilateral wireless earphone of a VR device according to the present disclosure, the first earphone comprises a first wireless audio receiving module, the second earphone comprises a second wireless audio receiving module, and they can receive the audio data that are broadcast by the wireless audio transmitting module of the VR device body. In other words, when experiencing the virtual reality technology, the user wears the VR device body on the head, and wears the first and second earphones on the left and right ears respectively, the audio data of the virtual reality are broadcasted by the VR device body through the wireless audio transmitting module, so that the first earphone and the second earphone can receive the audio data for playing. Specifically, after receiving the audio data, the first wireless audio receiving module of the first earphone obtains a first analog audio signal, such as the left sound channel audio signal, by converting from the audio data through the first audio processing module, and then sends it to the first speaker to play a sound. Similarly, after receiving the audio data, the second wireless audio receiving module of the second earphone obtains a second analog audio signal, such as the right sound channel audio signal, by converting from the audio data through the second audio processing module, and then sends it to the second speaker to play a sound. Compared with the existing head-mounted earphones used in the virtual reality experience, the bilateral wireless earphone according to the present disclosure is of an in-ear earbud type, which is small in size and light in weight. After wearing the VR device body, the big and heavy head-mounted earphones are not needed, and the first earphone and the second earphone are worn on the ear or inserted in the auricle, so it is convenient to wear and the head bearing weight is reduced, thereby avoiding or reducing the head fatigue in the virtual reality experience, and improving the experience effect.

In some embodiments, the wireless audio transmitting module 111 of the VR device body 11, the first wireless audio receiving module 121 of the first earphone 12, and the second wireless audio receiving module 131 of the second earphone 13 all adopt a module based on NFMI (Near Field Magnetic Induction) technology. The NFMI is a short-range radio technology that realizes wireless communication through magnetic field induction. It has the characteristics of low power consumption, low absorption by human body and high stability, etc., and is especially suitable for use in the present disclosure. Specifically, the wireless audio transmitting module 111 on the VR device body 11 adopts an NFMI transmitting module, and the first wireless audio receiving module 121 on the first earphone 12 and the second wireless audio receiving module 131 on the second earphone 13 both adopt a NFMI receiving module. The NFMI transmitting module establishes NFMI wireless communication with the two NFMI receiving modules respectively, thereby realizing the transmission of the audio data.

In some embodiments, the wireless audio transmitting module 111 of the VR device body 11, the first wireless audio receiving module 121 of the first earphone 12, and the second wireless audio receiving module 131 of the second earphone 13 may all adopt a module based on Bluetooth technology. Specifically, the wireless audio transmitting module 111 on the VR device body 11 adopts a Bluetooth transmitting module, and the first wireless audio receiving module 121 on the first earphone 12 and the second wireless audio receiving module 131 on the second earphone 13 both adopt a Bluetooth receiving module. The Bluetooth transmitting module establishes Bluetooth wireless communication with the two Bluetooth receiving modules respectively, thereby realizing the transmission of the audio data.

In some embodiments, the wireless audio transmitting module 111 of the VR device body 11, the first wireless audio receiving module 121 of the first earphone 12, and the second wireless audio receiving module 131 of the second earphone 13 may all adopt a module based on Zigbee technology. The Zigbee is a short-range, low-speed wireless network technology mainly used for short distance wireless connections. Specifically, the wireless audio transmitting module 111 on the VR device body 11 adopts a Zigbee transmitting module, and the first wireless audio receiving module 121 on the first earphone 12 and the second wireless audio receiving module 131 on the second earphone 13 both adopt a Zigbee receiving module. The Zigbee transmitting module establishes Zigbee wireless communication with the two Zigbee receiving modules respectively, thereby realizing the transmission of the audio data.

In some embodiments, the wireless audio transmitting module 111 of the VR device body 11, the first wireless audio receiving module 121 of the first earphone 12, and the second wireless audio receiving module 131 of the second earphone 13 may all adopt a module based on WIFI technology. Specifically, the wireless audio transmitting module 111 on the VR device body 11 adopts a WIFI transmitting module, and the first wireless audio receiving module 121 on the first earphone 12 and the second wireless audio receiving module 131 on the second earphone 13 both adopt a WIFI receiving module. The WIFI transmitting module establishes WIFI wireless communication with the two WIFI receiving modules respectively, thereby realizing the transmission of the audio data.

In some embodiments, the first earphone 12 further comprises a first audio processing module 122 and a first speaker 123, and the second earphone 13 further comprises a second audio processing module 132 and a second speaker 133.

After receiving the audio data that are broadcast by the wireless audio transmitting module 111 of the VR device body 11, the first wireless audio receiving module 121 demodulates the audio data first and then transmits the audio data to the first audio processing module 122. The first audio processing module 122 converts the audio data into a first analog audio signal, such as a left sound channel analog audio signal, and drives the first speaker 123 to play the first analog audio signal.

Similarly, after receiving the audio data that are broadcast by the wireless audio transmitting module 111 of the VR device body 11, the second wireless audio receiving module 131 demodulates the audio data first and then transmits the audio data to the second audio processing module 132. The second audio processing module 132 converts the audio data into a second analog audio signal, such as a right sound channel analog audio signal, and drives the second speaker 133 to play the second analog audio signal.

In the bilateral wireless earphone system of a VR device according to the present disclosure, the VR device body 11 functions as a master device, and after the audio file is modulated, it is broadcasted through an antenna such as an NFMI transmitting module. The first earphone 12 and the second earphone 13 function as slave devices. After the broadcasted audio data are received through the same type of antenna and module, the broadcasted audio data are demodulated and sent to the respective audio processing modules in a format such as I2S or PCM, and the audio processing module converts the digital audio data into an analog audio signal through DA conversion or the like, and drives the playback by the respective speakers, so that the user perceives the audio.

In some embodiments, in view of the fact that the first earphone 12 and the second earphone 13 are in-ear earbuds, which are small and light, a first recess 112 for accommodating the first earphone 12 and a second recess 113 for accommodating the second earphone 13 may be formed on the VR device body 11, to prevent the bilateral wireless earphone from being lost. Generally, the first earphone 12 and the second earphone 13 are respectively placed in the first recess 112 and the second recess 113 of the VR device body 11, which can prevent the earphones from being lost. When the user needs to experience the virtual reality technology, the first earphone 12 and the second earphone 13 can be conveniently taken out from the first recess 112 and the second recess 113. After use, the first recess 112 and the second recess 113 are placed back into the first recess 112 and the second recess 113 for convenient use in the next experience.

Based on the above, the present disclosure further provides a bilateral wireless earphone of a VR device, comprising a first earphone 12 and a second earphone 13, as shown in FIG. 1. The first earphone 12 comprises a first wireless audio receiving module 121. The second earphone 13 comprises a second wireless audio receiving module 131. The first wireless audio receiving module 121 and the second wireless audio receiving module 131 are both configured to receive the audio data that are broadcast by the wireless audio transmitting module of the VR device.

In some embodiments, the first earphone 12 further comprises a first audio processing module 122 and a first speaker 123, and the second earphone 13 further comprises a second audio processing module 132 and a second speaker 133. The first audio processing module 122 is configured to convert the audio data received by the first wireless audio receiving module 121 into a first analog audio signal, and the first speaker 123 is configured to play the first analog audio signal. The second audio processing module 132 is configured to convert the audio data received by the second wireless audio receiving module 131 into a second analog audio signal, and the second speaker 133 is configured to play the second analog audio signal.

The first earphone 12 and the second earphone 13 may be accommodated in the first recess 112 and the second recess 113 formed on the VR device respectively.

The methods of work and use of the bilateral wireless earphone of the VR device have been described in detail in the bilateral wireless earphone system of a VR device as stated above, so they will not be repeated herein.

The bilateral wireless earphone system of a VR device and the bilateral wireless earphone of the VR device according to the present disclosure can satisfy the requirement of audio playback effect of the virtual reality technology, and the earphone also has the advantages of small size, light weight, low power consumption, wirelessness and convenience to carry, and thus it is convenient to wear and the head bearing weight can be reduced, thereby solving the technical problem of the prior art that the head bearing weight is large in virtual reality experience.

The description provided herein illustrates many concrete details. However, it can be understood that, the embodiments of the present disclosure can be implemented without the concrete details. In some embodiments, well known methods, structures and techniques are not described in detail, so as not to obscure the understanding of the description. The languages used in the description are chosen mainly for sake of readability and teaching, and are not intended to interpret or define the subject matter of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A bilateral wireless earphone system of a VR device, comprising a VR device body, wherein
the bilateral wireless earphone system of a VR device further comprises a first earphone of in-ear earbud type and a second earphone of in-ear earbud type;
the VR device body comprises a wireless audio transmitting module;
the first earphone comprises a first wireless audio receiving module, and the second earphone comprises a second wireless audio receiving module; and
the wireless audio transmitting module is configured to broadcast audio data, and the first wireless audio receiving module and the second wireless audio receiving module are both configured to receive the audio data that are broadcast by the wireless audio transmitting module.

2. The bilateral wireless earphone system of a VR device according to claim 1, wherein
the first earphone further comprises a first audio processing module and a first speaker, and the second earphone further comprises a second audio processing module and a second speaker;
the first audio processing module is configured to convert the audio data received by the first wireless audio receiving module into a first analog audio signal, and the first speaker is configured to play the first analog audio signal; and
the second audio processing module is configured to convert the audio data received by the second wireless audio receiving module into a second analog audio signal, and the second speaker is configured to play the second analog audio signal.

3. The bilateral wireless earphone system of a VR device according to claim 1, wherein the VR device body is provided with a first recess for accommodating the first earphone, and a second recess for accommodating the second earphone.

4. The bilateral wireless earphone system of a VR device according to claim 1, wherein the wireless audio transmitting module is an NFMI transmitting module; the first wireless audio receiving module and the second wireless audio receiving module are both an NFMI receiving module.

5. The bilateral wireless earphone system of a VR device according to claim 1, wherein the wireless audio transmitting module is a Bluetooth transmitting module; the first wireless audio receiving module and the second wireless audio receiving module are both a Bluetooth receiving module.

6. The bilateral wireless earphone system of a VR device according to claim 1, wherein the wireless audio transmitting module is a Zigbee transmitting module; the first wireless audio receiving module and the second wireless audio receiving module are both a Zigbee receiving module.

7. The bilateral wireless earphone system of a VR device according to claim 1, wherein the wireless audio transmitting module is a WIFI transmitting module; the first wireless audio receiving module and the second wireless audio receiving module are both a WIFI receiving module.

8. A bilateral wireless earphone of a VR device, comprising: a first earphone of in-ear earbud type and a second earphone of in-ear earbud type; wherein
the first earphone comprises a first wireless audio receiving module, and the second earphone comprises a second wireless audio receiving module; and
the first wireless audio receiving module and the second wireless audio receiving module are both configured to receive the audio data that are broadcast by a wireless audio transmitting module of the VR device.

9. The bilateral wireless earphone of a VR device according to claim 8, wherein
the first earphone further comprises a first audio processing module and a first speaker, and the second earphone further comprises a second audio processing module and a second speaker;
the first audio processing module is configured to convert the audio data received by the first wireless audio receiving module into a first analog audio signal, and the first speaker is configured to play the first analog audio signal; and
the second audio processing module is configured to convert the audio data received by the second wireless audio receiving module into a second analog audio signal, and the second speaker is configured to play the second analog audio signal.

10. The bilateral wireless earphone of a VR device according to claim 8, wherein the first earphone and the second earphone are accommodated in a first recess and a second recess formed on the VR device respectively.
